(19) United States
(12) Patent Application Publication
(10) Pub. No.: US 2026/0185370 A1
(43) Pub. Date: Jul. 2, 2026

(54) METHOD FOR MANUFACTURING LARGE-DIAMETER CYLINDRICAL STORAGE TANK, METHOD FOR MANUFACTURING LARGE-DIAMETER CYLINDER FOR MARINE STRUCTURES, AND STORAGE TANK AND CYLINDER MANUFACTURED THEREBY

(71) Applicant: SEJIN HEAVY INDUSTRIES CO., LTD., Ulsan (KR)

(72) Inventor: Jiwon YOON, Ulsan (KR)

(73) Assignee: SEJIN HEAVY INDUSTRIES CO., LTD., Ulsan (KR)

(21) Appl. No.: 19/439,051

(22) Filed: Jan. 2, 2026

(30) Foreign Application Priority Data
Jan. 2, 2025 (KR) 10-2025-0000519
Jan. 2, 2025 (KR) 10-2025-0000520

(51) Int. Cl. E04H 7/30; B23K 26/24; B65D 88/08; B65D 90/02

(52) U.S. Cl. CPC E04H 7/30; B23K 26/24; B65D 88/08; B65D 90/024

(57) ABSTRACT

The present disclosure relates to a method for manufacturing a large-diameter cylindrical storage tank, a method for manufacturing a large-diameter cylinder for marine structures, and a storage tank and a cylinder manufactured thereby. The method for manufacturing the large-diameter cylindrical storage tank according to the present disclosure includes: manufacturing a single-pipe plate; forming a single pipe by bending the single-pipe plate into a cylindrical shape; arranging the single pipe in a horizontal posture so that a longitudinal welding portion formed in the single pipe bent into the cylindrical shape extends in a horizontal posture and completing the single pipe by welding the longitudinal welding portion; installing one or more ring frames inside the single pipe to closely contact an inner circumferential surface of the single pipe so as to support the single pipe; and installing a hemispherical head at an end of the single pipe to close the end.

### CROSS-REFERENCE TO RELATED APPLICATION

This application claims priorities under 35 U.S.C § 119 to Korean Patent Application Nos. 10-2025-0000519 and 10-2025-0000520, filed on Jan. 2, 2025 in the Korean Intellectual Property Office, the entire contents of which are hereby incorporated by reference.

### TECHNICAL FIELD

The present disclosure relates to a method for manufacturing a large-diameter cylindrical storage tank, a method for manufacturing a large-diameter cylinder for marine structures, and a storage tank and a cylinder manufactured thereby, and more particularly, to a method for manufacturing a large-diameter cylindrical storage tank, a method for manufacturing a large-diameter cylinder for marine structures, and a storage tank and a cylinder manufactured thereby, comprising: manufacturing a single-pipe plate by coupling a plurality of unit steel plates to have a length corresponding to a circumferential perimeter of a cylindrical storage tank to be manufactured or a large-diameter cylinder for forming a lower support of a marine structure to be manufactured; forming a single pipe by bending the single-pipe plate into a cylindrical shape; arranging the single pipe in a horizontal posture so that a longitudinal welding portion formed in the single pipe is located in a horizontal posture and enabling welding for the longitudinal welding portion through downward-looking welding by arranging the single pipe in the horizontal posture; and welding a circumferential welding portion formed between a pair of single pipes on the ground without installing scaffolding by arranging the pair of the single pipes in a horizontal posture on a rolling device even when a plurality of the single pipes are connected.

### BACKGROUND

In general, when natural gas, petroleum gas, and carbon dioxide are maintained in a liquid state, their volumes are reduced and stability is improved; therefore, by compressing these gases into a liquid state and storing them in a storage tank, efficiency of transportation and storage may be remarkably improved.

Particularly, carbon dioxide has a triple point higher than atmospheric pressure and thus cannot be maintained in a liquid state at atmospheric pressure; therefore, to transport carbon dioxide in a liquid state, high pressure reaching four to five times atmospheric pressure and a low temperature must be maintained, and particularly, since carbon dioxide easily changes between gaseous, liquid, and solid states, a liquefied carbon dioxide storage tank is manufactured by using a thick plate approximately 50% thicker than that of a liquefied petroleum gas storage tank so as to maintain stable high pressure and low temperature, thereby resulting in relatively high manufacturing difficulty.

Meanwhile, in the case of large-diameter storage tanks capable of storing a large amount of liquid, due to limitations in the size of steel plates that can be manufactured, a plurality of unit steel plates are joined together for manufacturing, and in the case of large-diameter cylinders that form lower supports provided in marine structures such as marine wind power generators or marine platforms for the extraction of marine resources to firmly fix the marine structures to a seabed, a plurality of unit steel plates are also joined together for manufacturing due to limitations in the size of steel plates that can be manufactured.

As a related prior art document regarding a storage tank manufactured by joining a plurality of unit steel plates in this manner, Japanese Patent Registration No. 5145485 (registered on Nov. 30, 2012, hereinafter referred to as “Prior Art Document 1”) has been proposed. The storage tank according to Prior Art Document 1 is configured such that, as shown in FIG. 1A, a plurality of sidewall units 1 are coupled in a circumferential direction to form a general member 2, and a plurality of the general members 2 are coupled to be stacked so that a large-diameter storage tank having a cylindrical shape is formed.

The storage tank of Prior Art Document 1 as described above intended to effectively suppress deformation of an outer wall of the tank in a circumferential direction due to welding heat when members constituting the sidewall unit are coupled, thereby enabling precise joining between the sidewall units so as to prevent liquid from leaking from a joint portion between the units.

However, in order to manufacture a large-diameter general member 2 by coupling a plurality of sidewall units 1 that are manufactured to have a predetermined curvature as in Prior Art Document 1, each of the sidewall units 1 must be individually subjected to bending processing, so that the number of bending processes required per tank is large, and since the number of uses of heavy equipment such as cranes or forklifts for handling the sidewall unit 1 during bending increases, a large amount of time and labor is required, and in addition, there is a problem in that efficient operation of the equipment is difficult.

In addition, in a process of circumferentially coupling the sidewall units that are bent to have the predetermined curvature, a large amount of time is required in order to increase joining precision between the sidewall units 1, and due to difficulty in welding automation, a worker must directly move to perform welding, so that a large amount of labor is required and welding quality varies depending on the skill of the worker, resulting in a problem in that the possibility of generating defects in welding portions increases.

Particularly, when two or more general members 2 are stacked in a vertical direction as shown in FIG. 1B, since the height reaches several meters to several tens of meters, temporary structures such as scaffolding or work platforms must be installed around the general members 2 prior to welding work for joining the general members 2, and after welding is completed, a process of dismantling the scaffolding and the work platforms is required, so that a large amount of labor and time must be spent in preparation before welding and in post-welding cleanup work, resulting in a problem in that a risk of a fall accident during high-altitude work is high.

Meanwhile, as a prior art document related to a large-diameter cylinder forming a lower support of a marine structure, Japanese Patent Application Publication No. 2011-115829 (published on Jun. 16, 2011, hereinafter referred to as “Prior Art Document 2”) has been proposed. As shown in FIG. 1C, a large welded steel pipe of Prior Art Document 2 is formed by welding and coupling a plurality of long-length arc-shaped steel materials 3.

The long-length arc-shaped steel material 3 is manufactured by bending a steel plate, and a large-diameter unit steel pipe is manufactured by coupling the plurality of long-length arc-shaped steel materials 3 by high-energy density beam welding in a state in which the long-length arc-shaped steel materials 3 are arranged radially to be adjacent to one another. Such Prior Art Document 2 intended to promote efficient production of a large welded steel pipe having good fracture toughness.

However, in order to manufacture a large-diameter unit steel pipe by bending and coupling a steel plate to have a predetermined curvature as in Prior Art Document 2, a large amount of time, labor, and equipment is required due to a large number of bending processes required per unit steel pipe, similarly to Prior Art Document 1, and there are problems in that the possibility of generating defects in welding portions is high and the risk of fall accidents during high-altitude work is high.

### PRIOR ART DOCUMENTS

### Patent Document

(Patent Document 1) Japanese Patent Registration No. 5145485 (registered on Nov. 30, 2012)
(Patent Document 2) Japanese Patent Application Publication No. 2011-115829 (published on Jun. 16, 2011)

### SUMMARY

The present disclosure has been made in order to solve the above-described problems, and an object of the present disclosure is to provide a method for manufacturing a large-diameter cylindrical storage tank, a method for manufacturing a large-diameter cylinder for marine structures, and a storage tank and a cylinder manufactured thereby, which may reduce the number of bending processes of unit steel plates and may facilitate automation of welding work for coupling the unit steel plates when manufacturing a large-diameter cylinder for forming a large-diameter storage tank or a lower support of a marine structure by coupling a plurality of unit steel plates.

Another object of the present disclosure is to provide a method for manufacturing a large-diameter cylindrical storage tank, a method for manufacturing a large-diameter cylinder for marine structures, and a storage tank and a cylinder manufactured thereby, in which installation of scaffolding or a work platform is not required and a risk of high-altitude work may be eliminated.

Still another object of the present disclosure is to provide a method for manufacturing a large-diameter cylindrical storage tank, a method for manufacturing a large-diameter cylinder for marine structures, and a storage tank and a cylinder manufactured thereby, which may implement fast and efficient fabrication while manufacturing a large-area single-pipe plate by using unit steel plates without distortion or deformation.

A method for manufacturing a large-diameter cylindrical storage tank of the present disclosure for performing a task to achieve the above-described objects and to eliminate conventional problems relates to a method for manufacturing a large-diameter cylindrical storage tank by coupling a plurality of unit steel plates 11, and includes a plate manufacturing step S110 of manufacturing a single-pipe plate 20 by welding a plurality of the unit steel plates 11 so that long sides 11a of the unit steel plates 11 having a rectangular shape are abutted and coupled to each other; a bending step S120 of forming a single pipe 30 by bending the single-pipe plate 20 into a cylindrical shape; a single-pipe manufacturing step S130 of arranging the single pipe 30 in a horizontal posture so that a longitudinal welding portion 31 formed in the single pipe 30 bent into the cylindrical shape extends in the horizontal posture, and completing the single pipe 30 by welding the longitudinal welding portion 31; a ring-frame installing step S140 of installing one or more ring frames 70 inside the single pipe 30 so as to closely contact an inner circumferential surface of the single pipe 30 to support the single pipe 30; and a hemispherical-head installing step S150 of installing a hemispherical head 40 at an end of the single pipe 30 and closing the end.

In addition, the plate manufacturing step S110 may include an expansion step S111 of repeatedly coupling, in pairs, assemblies formed by pairing and coupling the unit steel plates 11 or 2ⁿ (n being a natural number) unit steel plates 11, such that a length of each assembly is increased twofold.

In addition, the plate manufacturing step S110 may include a remaining unit steel plate coupling step S112 of additionally coupling a remaining unit steel plate 11′ that fails to form a pair in a process of performing the expansion step S111 to an assembly 10.

In addition, the method may further include a double-pipe manufacturing step S160 of arranging, on the rolling device 80 in a horizontal posture so as to be symmetric to each other, a pair of single pipes 30 each having the hemispherical head 40 provided at one end thereof, tack-welding the pair of single pipes 30, and welding a circumferential welding portion 32 while rotating the pair of single pipes 30 by the rolling device 80.

In addition, after the bending step S120, a reinforcing step S125 of installing reinforcements 60 at both ends of the single pipe 30 so that a shape of the single pipe 30 is maintained as a perfect circle; and after the single-pipe manufacturing step S130, a re-rolling step S135 of separating the reinforcements 60 from the single pipe 30 and correcting the completed single pipe 30 so as to approach a perfect circle may be further included.

In addition, the ring-frame installing step S140 may include a reinforcing step S141 of installing reinforcements 60 at both ends of the single pipe 30 so that a shape of the single pipe 30 is maintained as a perfect circle; a ring-frame temporary-fixing step S142 of temporarily fixing the ring frame 70 to the inner circumferential surface of the single pipe 30; a dismantling step S143 of separating the reinforcements 60 from the single pipe 30; and a ring-frame fixing step S144 of welding and fixing a circumference of the ring frame 70 to the single pipe 30 so that the ring frame 70 is completely fixed to the inner circumferential surface of the single pipe 30.

In addition, the ring-frame fixing step S144 may include a single-pipe loading step S1441 of loading the single pipe 30 on the rolling device 80; a circumferential welding step S1442 of welding and fixing a circumference of the ring frame 70 to the single pipe 30 by rotating the single pipe 30 by the rolling device 80 in a state in which a welding torch whose position is adjusted by a manipulator 90 is positioned at a welding position of the ring frame 70 in the single pipe 30; and a repeating step S1443 of sequentially fixing a plurality of the ring frames 70 to the single pipe 30 by moving the welding torch in a longitudinal direction of the single pipe 30 by the manipulator 90 and repeating the circumferential welding step S1442.

And, the reinforcement 60 includes a pair of clamps 61 coupled to an end of the single pipe 30 so as to be symmetric with each other in a radial direction of the single pipe 30, and a rod 62 connecting the pair of the clamps 61, and a plurality of the reinforcements 60 may be installed at both ends of the single pipe 30 so that a plurality of the clamps 61 are radially coupled to both ends of the single pipe 30.

Meanwhile, a large-diameter cylindrical storage tank of the present disclosure is characterized by being manufactured by the above-described method for manufacturing a large-diameter cylindrical storage tank.

Meanwhile, the method for manufacturing a large-diameter cylindrical storage tank of the present disclosure relates to a method for manufacturing a large-diameter cylindrical storage tank by coupling a plurality of unit steel plates 11, and includes a plate manufacturing step S110 of manufacturing a single-pipe plate 20 by welding a plurality of the unit steel plates 11 so that long sides 11a of the unit steel plates 11 having a rectangular shape are abutted and coupled to each other, wherein an assembly formed by pairing and coupling the unit steel plates 11 or 2ⁿ (n being a natural number) unit steel plates 11 forms an expanded assembly by forming welding portions, for heat treatment for a straightening process, such that a length of each newly expanded assembly is increased twofold; a bending step S120 of forming a single pipe 30 by bending the single-pipe plate 20 into a cylindrical shape; a reinforcing step S125 of installing reinforcements 60 at both ends of the single pipe 30 that is arranged in a horizontal posture so that a shape of the single pipe 30 bent into a cylindrical shape is maintained as a perfect circle; a single-pipe manufacturing step S130 of arranging the single pipe 30 in a horizontal posture so that a single longitudinal welding portion 31 formed in the single pipe 30 bent into a cylindrical shape extends in a horizontal posture, and completing the single pipe 30 by welding the longitudinal welding portion 31; a ring-frame installing step S140 of installing, inside the single pipe 30, one or more ring frames 70 that closely contact an inner circumferential surface of the single pipe 30 to support the single pipe 30, the ring-frame installing step S140 including: a reinforcing step S141 of installing a plurality of reinforcements 60 at both ends of the single pipe 30 arranged in a horizontal posture so that a shape of the single pipe 30 is maintained as a perfect circle, a ring-frame temporary-fixing step S142 of temporarily fixing the ring frame 70 divided into a plurality of unit segments to the inner circumferential surface of the single pipe 30, a dismantling step S143 of separating the reinforcements 60 from the single pipe 30, and a ring-frame fixing step S144 of fixing the ring frame 70 to the single pipe 30 by welding a circumference of the ring frame 70 so that the ring frame 70 is completely fixed to an inner circumferential surface of the single pipe 30; and a hemispherical-head installing step S150 of installing a hemispherical head 40 at an end of the single pipe 30 and closing the end, and is characterized in that in each of the reinforcements 60, a pair of clamps 61 is fitted to an end of the single pipe 30 so as to be symmetric with each other in the radial direction of the single pipe 30, and the pair of clamps 61 is connected by the rod 62, and a plurality of the reinforcements 60 are installed at both ends of the single pipe 30 so that a plurality of the clamps 61 are radially coupled to both ends of the single pipe 30.

Meanwhile, the method for manufacturing a large-diameter cylinder for marine structures of the present disclosure relates to a method for manufacturing a large-diameter cylinder for marine structures, the large-diameter cylinder being for forming a lower support of a marine structure, by coupling a plurality of unit steel plates 11, and includes a plate manufacturing step S210 of manufacturing a single-pipe plate 20 by welding a plurality of the unit steel plates 11 so that long sides 11a of the unit steel plates 11 having a rectangular shape are abutted and coupled to each other; a bending step S220 of forming a single pipe 30 by bending the single-pipe plate 20 into a cylindrical shape; a single-pipe manufacturing step S230 of arranging the single pipe 30 in a horizontal posture so that a longitudinal welding portion 31 formed in the single pipe 30 bent into a cylindrical shape extends in a horizontal posture, and completing the single pipe 30 by welding the longitudinal welding portion 31; and a ring-frame installing step S240 of installing, inside the single pipe 30, one or more ring frames 70 that closely contact an inner circumferential surface of the single pipe 30 to support the single pipe 30.

In addition, after the ring-frame installing step S240, a double-pipe manufacturing step S250 of arranging a pair of the single pipes 30 in a horizontal posture on the rolling device 80, tack-welding a circumferential welding portion 32 formed between the pair of the single pipes 30, and welding the circumferential welding portion 32 while rotating the pair of the single pipes 30 by the rolling device 80 may be further included.

In addition, the plate manufacturing step S210 may include an expansion step S211 of repeatedly coupling, in pairs, assemblies formed by pairing and coupling the unit steel plates 11 or 2ⁿ (n being a natural number) unit steel plates 11, such that a length of each assembly is increased twofold.

In addition, the plate manufacturing step S210 may include a remaining unit steel plate coupling step S212 of additionally coupling a remaining unit steel plate 11′ that fails to form a pair in a process of performing the expansion step S211 to an assembly 10.

In addition, after the bending step S220, a reinforcing step S225 of installing reinforcements 60 at both ends of the single pipe 30 so that a shape of the single pipe 30 is maintained as a perfect circle; and after the single-pipe manufacturing step S230, a re-rolling step S235 of separating the reinforcements 60 from the single pipe 30 and correcting the completed single pipe 30 so as to approach a perfect circle may be further included.

In addition, the ring-frame installing step S240 may include a reinforcing step S241 of installing reinforcements 60 at both ends of the single pipe 30 so that a shape of the single pipe 30 is maintained as a perfect circle; a ring-frame temporary-fixing step S242 of temporarily fixing the ring frame 70 to the inner circumferential surface of the single pipe 30; a dismantling step S243 of separating the reinforcements 60 from the single pipe 30; and a ring-frame fixing step S244 of welding and fixing a circumference of the ring frame 70 to the single pipe 30 so that the ring frame 70 is completely fixed to the inner circumferential surface of the single pipe 30.

In addition, the ring-frame fixing step S244 may include a single-pipe loading step S2441 of loading the single pipe 30 on the rolling device 80; a circumferential welding step S2442 of welding and fixing a circumference of the ring frame 70 to the single pipe 30 by rotating the single pipe 30 by the rolling device 80 in a state in which a welding torch whose position is adjusted by a manipulator 90 is positioned at a welding position of the ring frame 70 in the single pipe 30; and a repeating step S2443 of sequentially fixing a plurality of the ring frames 70 to the single pipe 30 by moving the welding torch in a longitudinal direction of the single pipe 30 by the manipulator 90 and repeating the circumferential welding step S2442.

And, the reinforcement 60 includes a pair of clamps 61 coupled to an end of the single pipe 30 so as to be symmetric with each other in a radial direction of the single pipe 30, and a rod 62 connecting the pair of the clamps 61, and a plurality of the reinforcements 60 may be installed at both ends of the single pipe 30 so that a plurality of the clamps 61 are radially coupled to both ends of the single pipe 30.

Meanwhile, the large-diameter cylinder for marine structures according to the present disclosure is manufactured by the method for manufacturing a large-diameter cylinder for marine structures described above.

Meanwhile, the method for manufacturing a large-diameter cylinder for marine structures of the present disclosure relates to a method for manufacturing, by coupling a plurality of unit steel plates 11, a large-diameter cylinder for forming a lower support of a marine structure, and includes a plate manufacturing step S210 of manufacturing a single-pipe plate 20 by welding a plurality of the unit steel plates 11 so that long sides 11a of the unit steel plates 11 having a rectangular shape are abutted and coupled to each other, wherein an assembly formed by pairing and coupling the unit steel plates 11 or 2ⁿ (n being a natural number) unit steel plates 11 forms an expanded assembly such that a length of the assembly is increased twofold, and wherein only one new welding portion is formed in each newly expanded assembly for heat treatment for a straightening process; a bending step S220 of forming a single pipe 30 by bending the single-pipe plate 20 into a cylindrical shape; a reinforcing step S225 of installing reinforcements 60 at both ends of the single pipe 30 arranged in a horizontal posture so that a shape of the single pipe 30 bent into the cylindrical shape is maintained as a perfect circle; a single-pipe manufacturing step S230 of arranging the single pipe 30 in a horizontal posture so that a longitudinal welding portion 31 formed in the single pipe 30 bent into the cylindrical shape extends in a horizontal posture, and completing the single pipe 30 by welding the longitudinal welding portion 31; and a ring-frame installing step S240 of installing, inside the single pipe 30, one or more ring frames 70 that closely contact an inner circumferential surface of the single pipe 30 to support the single pipe 30, the ring-frame installing step S240 including a reinforcing step S241 of installing a plurality of reinforcements 60 at both ends of the single pipe 30 arranged in a horizontal posture so that a shape of the single pipe 30 is maintained as a perfect circle, a ring-frame temporary-fixing step S242 of temporarily fixing the ring frame 70 divided into a plurality of unit segments to the inner circumferential surface of the single pipe 30, a dismantling step S243 of separating the reinforcements 60 from the single pipe 30, and a ring-frame fixing step S244 of fixing the ring frame 70 to the inner circumferential surface of the single pipe 30 by welding a circumference of the ring frame 70, wherein, in each of the reinforcements 60, a pair of clamps 61 is fitted to an end of the single pipe 30 so as to be symmetric with each other in a radial direction of the single pipe 30, the pair of clamps 61 is connected by a rod 62, and a plurality of the reinforcements 60 are installed at both ends of the single pipe 30 so that a plurality of the clamps 61 are radially coupled to both ends of the single pipe 30.

According to a method for manufacturing a large-diameter cylindrical storage tank, a method for manufacturing a large-diameter cylinder for marine structures, and a storage tank and a cylinder manufactured thereby of the present disclosure, since a plurality of unit steel plates are welded and coupled in advance to have a length corresponding to a circumferential perimeter of a storage tank or a large-diameter cylinder to be manufactured and then bent, the number of bending operations may be remarkably reduced, thereby improving productivity.

In particular, since the plurality of unit steel plates may be coupled through downward-looking welding on the ground in a flat state, automation of welding work for coupling the unit steel plates is facilitated, and quality of welding portions is improved, thereby preventing leakage of gas due to defects in welding portions and minimizing salt corrosion.

Furthermore, in welding a longitudinal welding portion of a single pipe bent into a cylindrical shape through bending processing, since the single pipe is arranged in a horizontal posture such that the longitudinal welding portion is located downward in a horizontal posture and the longitudinal welding portion may be welded by downward-looking welding from an inner side of the single pipe, automation of welding work is facilitated and quality of the welding portion is improved, thereby more stably preventing leakage of gas due to defects in the welding portion and preventing degradation of durability of a marine structure.

In addition, by welding such that a length of each assembly increases twofold, efficiency of correction processes and straightening processes may be improved, and a flat single-pipe plate may be manufactured without local twisting or deformation caused by forming a large-area single-pipe plate.

Moreover, since most welding work may be performed on the ground, installation of temporary structures such as scaffolding or work platforms is not required, thereby reducing labor and time for installation and dismantling of scaffolding or work platforms, and omitting high-level work, so that safety accidents may be prevented in advance.

### BRIEF DESCRIPTION OF THE DRAWINGS

FIG. 1A is a perspective view of a liquid storage tank according to Prior Art Document 1.

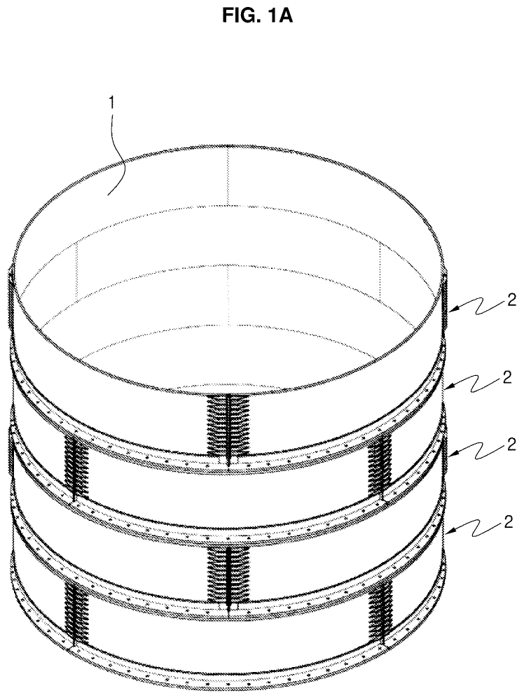

FIG. 1B is an image illustrating a conventional manufacturing method accompanied by high-altitude work.

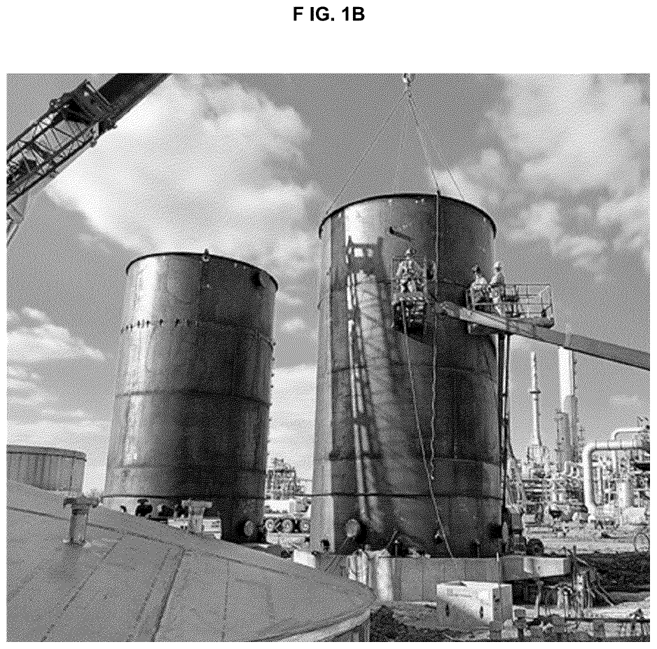

FIG. 1C is a perspective view of a large welded steel pipe according to Prior Art Document 2.

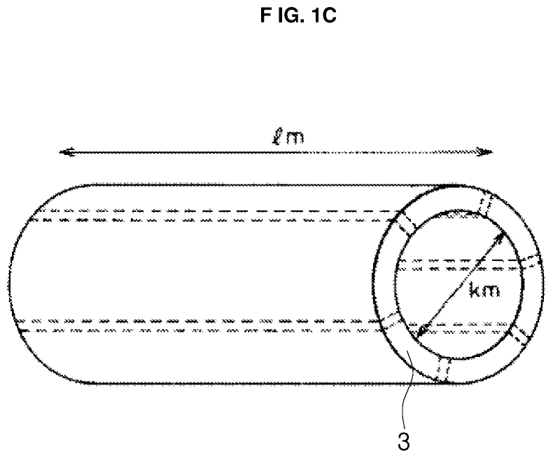

FIG. 2 is a block diagram illustrating, in chronological order, a method for manufacturing a large-diameter cylindrical storage tank according to an embodiment of the present disclosure.

FIG. 3 is an illustrative view illustrating a process in which a single-pipe plate is formed according to an embodiment of the present disclosure.

FIG. 4A is an illustrative view illustrating a state in which an automatic welding device is arranged above unit steel plates arranged side by side.

FIG. 4B is an illustrative view illustrating a process of correcting plate deformation of an assembly.

FIG. 5 is an illustrative view illustrating a state in which a single-pipe plate is bent to form a single pipe according to an embodiment of the present disclosure.

FIG. 6 is a perspective view illustrating a state in which reinforcements are installed on a single pipe according to an embodiment of the present disclosure.

FIG. 7 is a perspective view illustrating a state in which a longitudinal welding portion of a single pipe is welded according to an embodiment of the present disclosure.

FIG. 8A is a perspective view illustrating a state in which reinforcements are installed on a single pipe according to an embodiment of the present disclosure.

FIG. 8B is a perspective view illustrating a state in which a ring frame is temporarily fixed to a single pipe according to an embodiment of the present disclosure.

FIG. 8C is a perspective view illustrating a state in which reinforcements installed on a single pipe are dismantled according to an embodiment of the present disclosure.

FIG. 8D is a perspective view illustrating a state in which a single pipe is mounted on a rolling device and a ring frame is welded according to an embodiment of the present disclosure.

FIG. 9 is a perspective view illustrating a state in which a hemispherical head is arranged at an end of a single pipe according to an embodiment of the present disclosure.

FIG. 10 is a perspective view of a storage tank formed by coupling a pair of single pipes each having a hemispherical head installed thereon.

FIG. 11 is a block diagram illustrating, in chronological order, a method for manufacturing a large-diameter cylinder according to an embodiment of the present disclosure.

FIG. 12 is a perspective view illustrating a state in which reinforcements are installed on a single pipe for forming a large-diameter cylinder.

FIG. 13 is a perspective view illustrating a state in which a longitudinal welding portion of a single pipe for forming a large-diameter cylinder is welded.

FIG. 14A is a perspective view illustrating a state in which reinforcements are installed on a single pipe for forming a large-diameter cylinder.

FIG. 14B is a perspective view illustrating a state in which a ring frame is temporarily fixed to a single pipe for forming a large-diameter cylinder.

FIG. 14C is a perspective view illustrating a state in which reinforcements installed on a single pipe for forming a large-diameter cylinder are dismantled.

FIG. 14D is a perspective view illustrating a state in which a ring frame is welded to a single pipe for forming a large-diameter cylinder.

FIG. 15 is a perspective view illustrating a state in which a pair of single pipes for forming a large-diameter cylinder are arranged on a rolling device and welded together.

FIG. 16 is an illustrative view of a marine structure in which a large-diameter cylinder according to an embodiment of the present disclosure is used.

### DETAILED DESCRIPTION OF THE PREFERRED EMBODIMENTS

Hereinafter, a preferred embodiment of the present disclosure will be described in detail based on the matters illustrated in the drawings. However, detailed descriptions of related known functions or configurations will be omitted when it is determined that such descriptions may unnecessarily obscure the gist of the present disclosure.

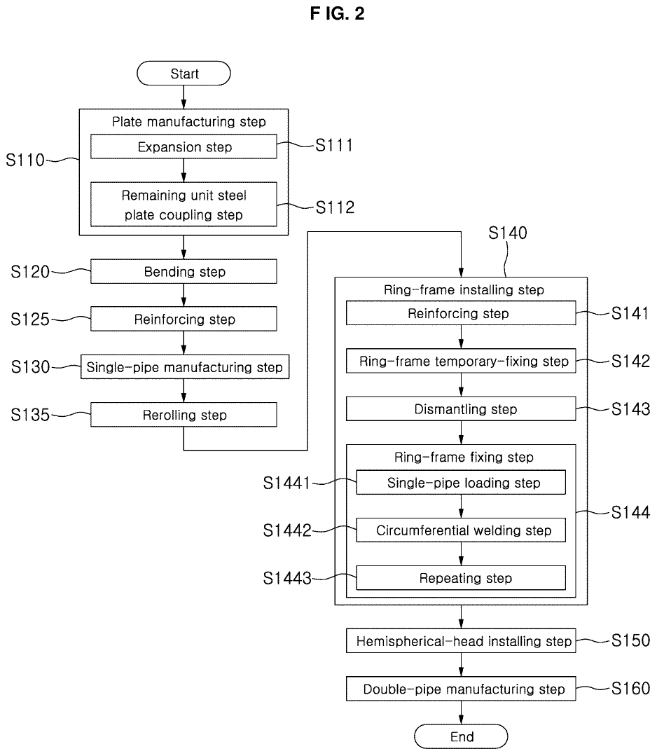

A method for manufacturing a large-diameter cylindrical storage tank according to an embodiment of the present disclosure manufactures a large-diameter storage tank having an inner diameter of several meters or more by coupling a plurality of unit steel plates 11, and, as shown in FIG. 2, is sequentially performed by including a plate manufacturing step S110, a bending step S120, a single-pipe manufacturing step S130, a ring-frame installing step S140, and a hemispherical-head installing step S150.

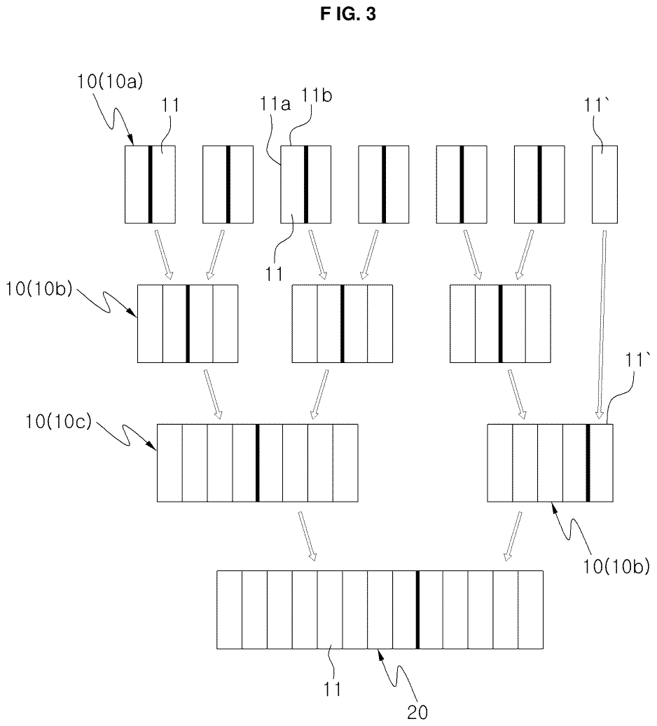

The plate manufacturing step S110 is a step of manufacturing a single-pipe plate 20 having a length corresponding to a circumferential perimeter of a storage tank to be manufactured, and, as shown in FIG. 3, the single-pipe plate 20 is formed by coupling a plurality of unit steel plates 11.

Each of the unit steel plates 11 has a rectangular shape so as to include a long side 11a having a relatively long length and a short side 11b having a relatively short length, and the plurality of unit steel plates 11 are coupled by welding such that the long sides 11a are abutted against each other.

As described above, since the plate manufacturing step S110 of the present disclosure manufactures the single-pipe plate 20 having a length corresponding to the circumferential perimeter of the storage tank by coupling the plurality of unit steel plates 11 before bending the unit steel plates 11, welding between the unit steel plates 11 may be performed through downward-looking welding on the ground, whereby installation of scaffolding for high-altitude work is not required, quality of welding portions may be improved through the downward-looking welding, and welding work may be easily automated, which constitute major technical distinctions of the present disclosure.

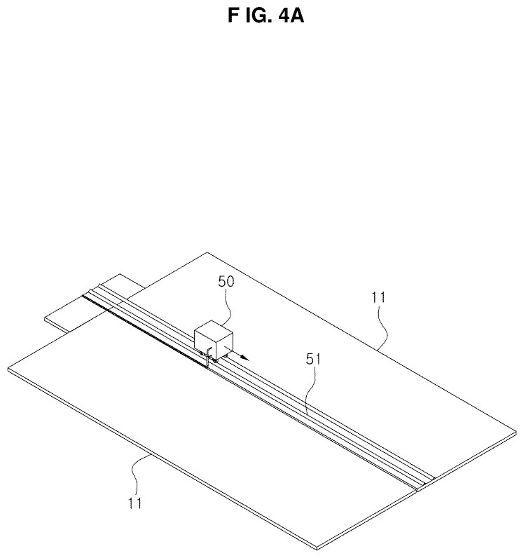

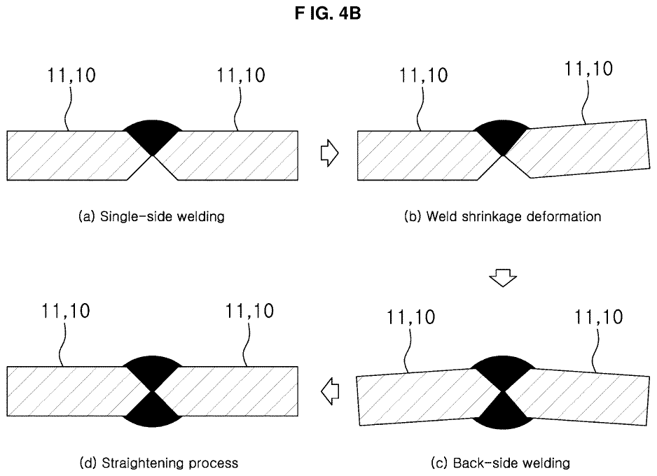

That is, as shown in FIG. 4A, the unit steel plates 11 are arranged side by side on a surface plate, not shown, and a welding device 50 may perform automatic welding while moving in a horizontal direction along a rail 51 at joints between the unit steel plates 11, or a welding torch 91 installed on a manipulator 90, which will be described later, may perform automatic welding while being moved along the joints between the unit steel plates 11 by the manipulator 90.

The plate manufacturing step S110 further includes an expansion step S111 of increasing a length of an assembly 10, formed by coupling two or more unit steel plates 11, such that a length of the assembly is increased twofold, in order to enable efficient operation of the surface plate on which welding work for coupling the unit steel plates 11 is performed and to smoothly perform a series of correction operations for correcting plate deformation of the assembly 10 or the single-pipe plate 20 caused by weld shrinkage deformation.

That is, as shown in FIG. 3, in the expansion step S111, two unit steel plates 11 are coupled to form a first assembly 10a, the first assembly 10a formed of two unit steel plates 11 is further coupled to form an expanded second assembly 10b formed of four unit steel plates 11, and the second assembly 10b formed of four unit steel plates 11 is further coupled to form a more expanded third assembly 10c formed of eight unit steel plates 11, and by repeating such a process, a length of an assembly 10 in which 2ⁿ (n being a natural number) unit steel plates 11 are coupled may be increased twofold.

As described above, since a first assembly 10a formed by coupling a pair of unit steel plates 11, and expanded second and third assemblies 10b and 10c formed by further coupling the first assembly 10a, always have a single new welding portion formed therein, when performing a series of correction operations on the newly formed welding portion of each assembly 10, the correction operations may be effectively performed through localized management at a single point.

In addition, as shown in FIG. 4B, during heat treatment of a straightening process performed after back-side welding for correcting plate deformation caused by welding shrinkage on one side, a plurality of assemblies 10 may be heat-treated at one time, thereby significantly reducing time required for the straightening process, and since the plurality of assemblies 10 formed by coupling the unit steel plates 11 all have the same size, repetitive correction operations may be easily performed, thereby improving work efficiency.

In particular, by welding such that a length of each assembly 10 increases twofold, efficiency of correction processes and straightening processes may be improved, and a flat single-pipe plate 20 may be manufactured without local twisting or deformation caused by forming a large-area single-pipe plate 20.

In addition, the plate manufacturing step S110 includes a remaining unit steel plate coupling step S112 of additionally coupling a remaining unit steel plate 11′, which fails to be paired during performance of the expansion step S111, to an assembly 10.

That is, as shown in FIG. 3, when coupling a plurality of unit steel plates 11 in pairs corresponding to a circumferential perimeter of a storage tank to be manufactured, if a remaining unit steel plate 11′ that fails to be paired exists, the remaining unit steel plate 11′ may be additionally coupled to an assembly 10 composed of two or more unit steel plates 11.

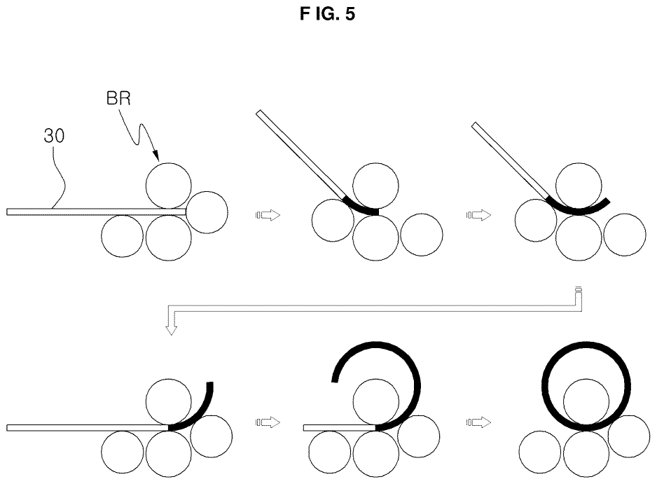

The bending step S120 is a step of forming a cylindrical single pipe 30 by bending a flat single-pipe plate 20, and, as shown in FIG. 5, the single-pipe plate 20 be bent by bending rollers BR and processed into the cylindrical single pipe 30, and although a process of bending by four-roll-type bending rollers BR is illustrated in FIG. 5, the single-pipe plate 20 may also be bent by three-roll-type bending rollers.

Meanwhile, after the bending step S120, a reinforcing step S125 of installing reinforcements 60 on the single pipe 30 may be performed to support the single pipe 30, which is formed by bending the single-pipe plate 20 into a cylindrical shape, so that the single pipe 30 is maintained in a perfect cylindrical shape.

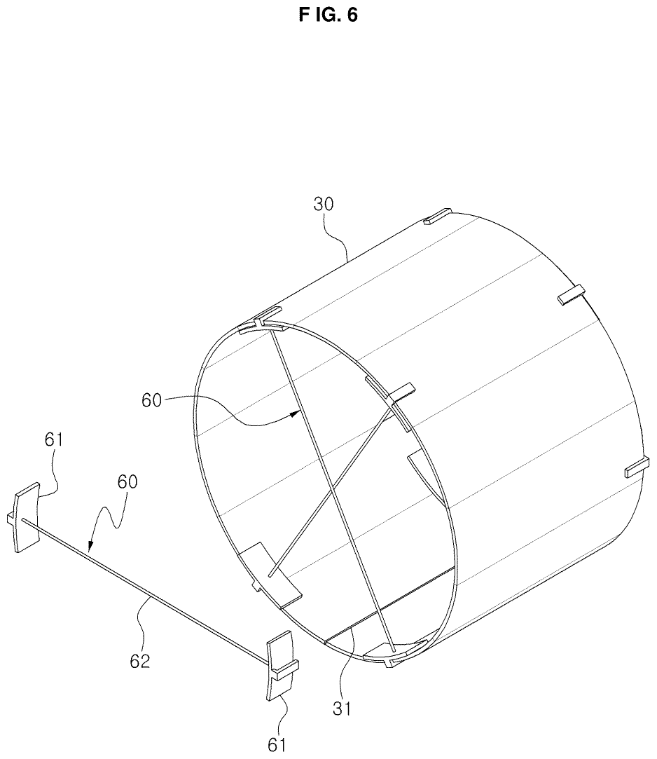

As shown in FIG. 6, each of the reinforcements 60 includes a pair of clamps 61 coupled to an end of the single pipe 30 so as to be symmetric with each other in a radial direction of the single pipe 30, and a rod 62 connecting the pair of clamps 61 to each other, wherein the clamps 61 are fitted to the end of the single pipe 30, and the rod 62 may include a turnbuckle so as to be adjustable in length.

Meanwhile, the reinforcements 60 are respectively installed at both ends of the single pipe 30, and a plurality of the reinforcements 60 are installed at both ends of the single pipe 30 in a crossed manner such that a plurality of the clamps 61 are radially coupled to both ends of the single pipe 30.

As described above, it is preferable that the reinforcements 60 installed on the single pipe 30 remain installed at both ends of the single pipe 30 until the single pipe 30 is completed by welding the longitudinal welding portion 31 of the single pipe 30.

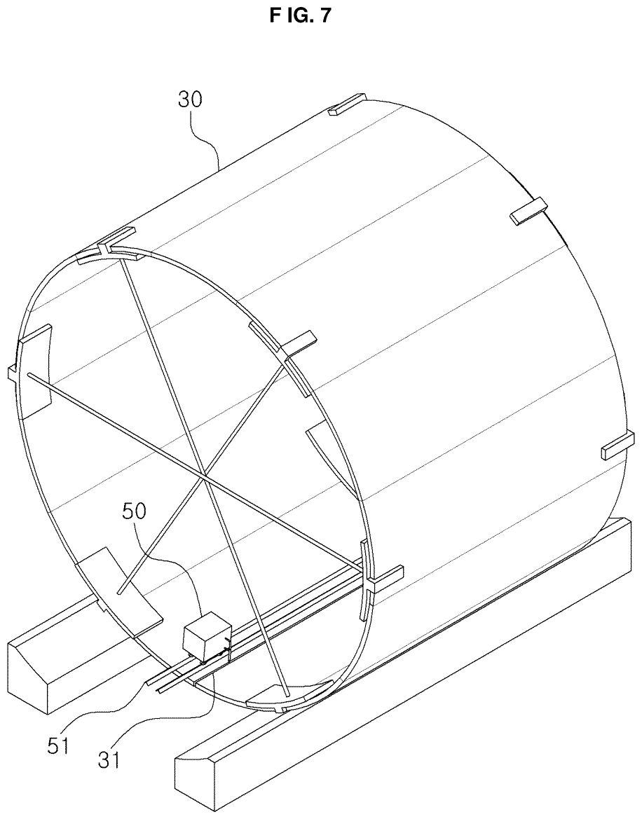

The single-pipe manufacturing step S130 is a step of welding a longitudinal welding portion 31 formed in a single pipe 30 bent into a cylindrical shape, and, as shown in FIG. 7, the single pipe 30 is arranged on a welding bed in a horizontal posture, and is preferably arranged such that the longitudinal welding portion 31 extends in a horizontal posture at a lower side.

When the single pipe 30 is arranged on the welding bed in the horizontal posture as described above, the longitudinal welding portion 31 is positioned at a relatively low location, and thus the longitudinal welding portion 31 may be welded through welding work performed on the ground without installing scaffolding, thereby completing the single pipe 30.

In addition, by temporarily installing a rail 51 for traveling of an automatic welding device 50 inside the single pipe 30 so as to be parallel to the longitudinal welding portion 31, welding of the longitudinal welding portion 31 by using the automatic welding device 50 is possible, and automatic welding by a welding torch 91 installed on and moved by a manipulator 90 is also possible.

As described above, an inner circumferential surface of the longitudinal welding portion 31 may be automatically welded by the automatic welding device 50 or the welding torch 91 of the manipulator 90, and an outer circumferential surface of the longitudinal welding portion 31 may be automatically welded by a welding gantry 100.

After the single-pipe manufacturing step S130 as described above, a rerolling step S135 may be performed by separating and dismantling the reinforcements 60 installed at both ends of the single pipe 30 from the single pipe 30, and bending the completed single pipe 30 again by using the bending rollers BR so as to correct the single pipe 30 to be close to a perfect circle.

The ring-frame installing step S140 is a step of installing a ring frame 70 inside a completed single pipe 30 to support the single pipe 30 so that additional deformation of the single pipe 30 is suppressed, and, as shown in FIG. 2, is sequentially performed by including a reinforcing step S141, a ring-frame temporary-fixing step S142, a dismantling step S143, and a ring-frame fixing step S144.

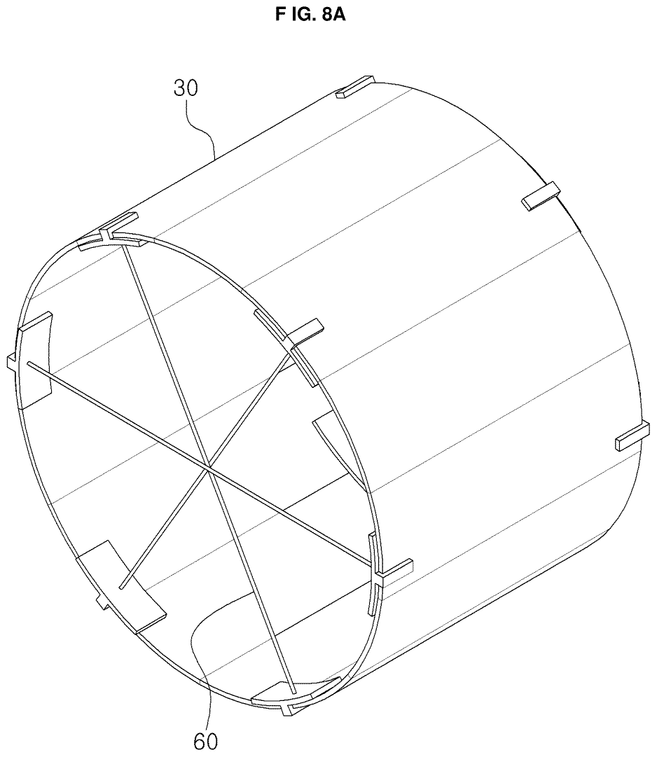

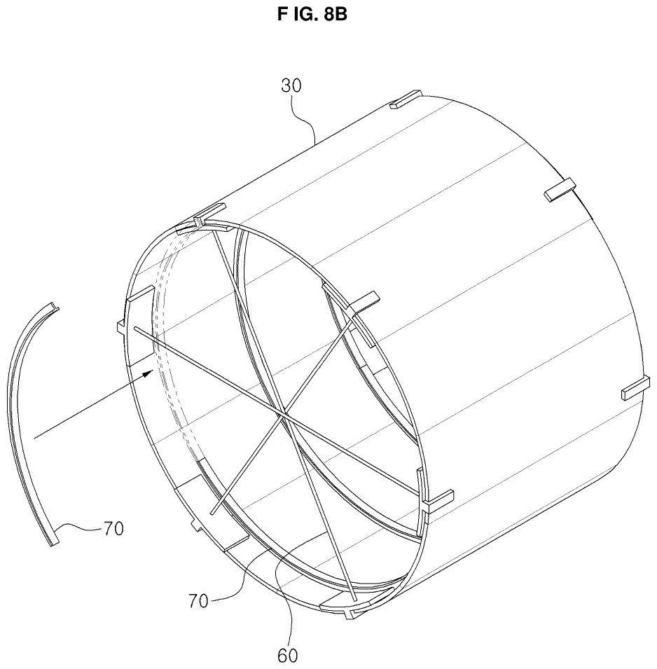

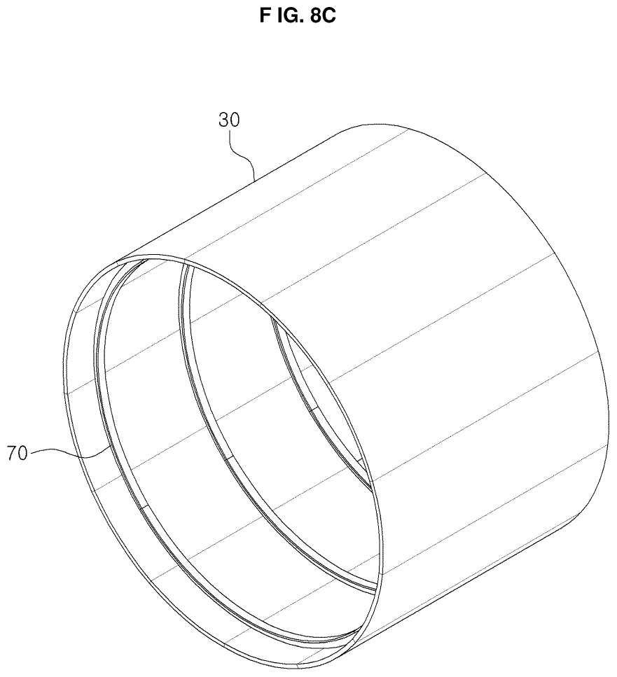

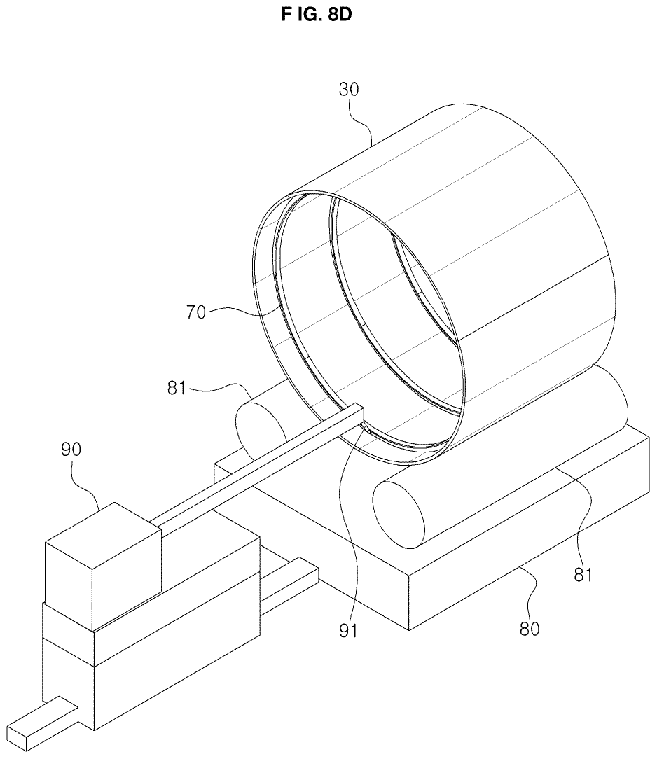

The reinforcing step S141 is a step of installing reinforcements 60 at both ends of the single pipe 30, and, as shown in FIG. 8A, a plurality of the reinforcements 60 are installed at both ends of the single pipe 30 in a manner crossing each other so as to support ends of the single pipe 30 in a perfect circular shape. As described above, since the ring frame 70 is welded and fixed inside the single pipe 30 in a state in which the plurality of reinforcements 60 are installed at both ends of the single pipe 30, deformation of the single pipe 30 caused by welding heat may be suppressed.

Such a reinforcing step S141 is performed immediately after a correction step S135 of correcting the completed single pipe 30 to a perfect circular shape by performing roll bending again, whereby deformation of the single pipe 30 may be prevented even during transportation of the single pipe 30.

The ring-frame temporary-fixing step S142 is a step of temporarily installing the ring frame 70 inside the single pipe 30, and, as shown in FIG. 8B, the ring frame 70 has an overall circular ring structure, but is divided into a plurality of unit segments so as to be easily inserted into the single pipe 30 through spaces between the reinforcements 60 installed at an end of the single pipe 30, and the unit segments are tack-welded so as to closely contact an inner circumferential surface of the single pipe 30 and thereby fixed inside the single pipe 30, such that the plurality of unit segments form the circular ring structure and are installed to entirely closely contact the inner circumferential surface of the single pipe 30.

As described above, by repeating, along a longitudinal direction of the single pipe 30, a process of temporarily fixing the ring frame 70 inside the single pipe 30 by tack-welding a plurality of unit segments to an inner circumferential surface of the single pipe 30, a plurality of ring frames 70 may be distributedly installed inside the single pipe 30.

The dismantling step S143 is a step of removing the reinforcements 60 installed on the single pipe 30, and, as shown in FIG. 8C, after the ring frame 70 is temporarily fixed inside the single pipe 30, the plurality of reinforcements 60 installed at both ends of the single pipe 30 are separated from the single pipe 30 and dismantled.

The ring-frame fixing step S144 is a step of completely fixing the temporarily fixed ring frame 70 to the single pipe 30, wherein the ring frame 70 is completely fixed by welding a circumference of the ring frame 70 to the single pipe 30.

Such a ring-frame fixing step S144 includes, as shown in FIG. 2, a single-pipe loading step S1441, a circumferential welding step S1442, and a repeating step S1443 so as to be performed through automatic welding without installing scaffolding or work platforms.

As shown in FIG. 8D, the single-pipe loading step S1441 is a step of loading the single pipe 30, in which the ring frame 70 is temporarily fixed, on a rolling device 80, wherein the single pipe 30 is mounted on the rolling device 80 in a horizontal posture.

The rolling device 80 includes a pair of rotating rollers 81 supporting a single pipe 30 from below, and at least one of the pair of rotating rollers 81 may be rotated by a motor to rotate the single pipe 30.

The circumferential welding step S1442 is a step of welding and fixing a circumference of the ring frame 70 to the single pipe 30, wherein a welding torch 91 whose position is adjusted by a manipulator 90 is positioned to fix the ring frame 70 to the single pipe 30 by downward-looking welding, and the single pipe 30 is rotated at a constant speed by the rolling device 80, whereby the circumference of the ring frame 70 may be welded and fixed to the single pipe 30 without performing high-altitude work.

The repeating step S1443 is a step of completely fixing a plurality of ring frames 70 to the single pipe 30 by repeatedly performing the circumferential welding step S1442 while moving the welding torch 91 in a longitudinal direction of the single pipe 30, wherein the welding torch 91 is moved by the manipulator 90 to a next welding position located along the longitudinal direction of the single pipe 30 and performs welding along the circumference of the ring frame 70 from an inside of the rotating single pipe 30, and by repeating such a process, the plurality of ring frames 70 may be sequentially and completely fixed to the single pipe 30.

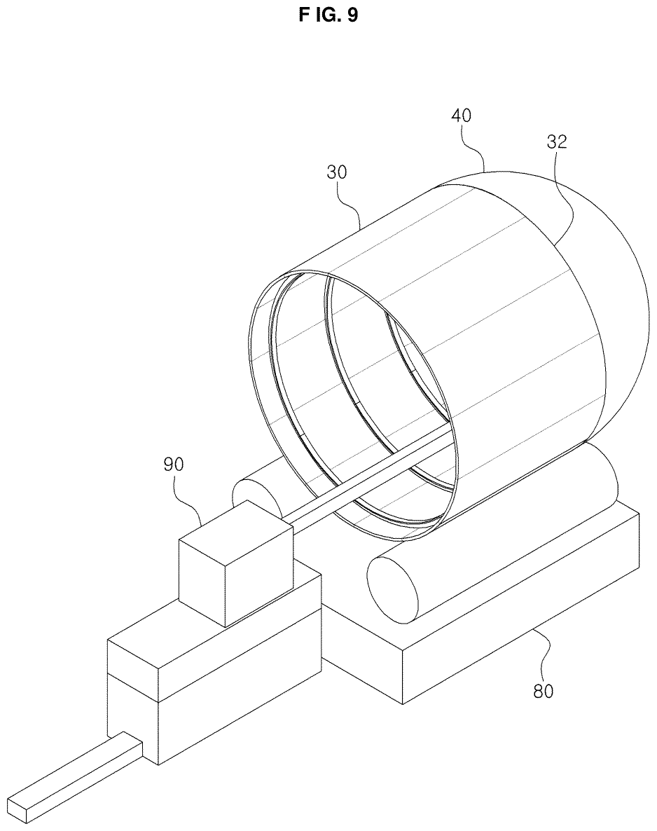

The hemispherical-head installing step S150 is a step of installing a hemispherical head 40 at an end of the single pipe 30, and, as shown in FIG. 9, the hemispherical head 40 may be lifted by a crane or a forklift and arranged to closely contact the end of the single pipe 30 placed on the rolling device 80, and be tack-welded to be temporarily fixed to the single pipe 30, and in a state in which the welding torch 91 provided on the manipulator 90 is positioned at a circumferential welding portion 32 formed between the single pipe 30 and the hemispherical head 40, the rolling device 80 operates to rotate the single pipe 30 at a constant speed, whereby an inner circumferential surface of the circumferential welding portion 32 formed between the single pipe 30 and the hemispherical head 40 may be welded on the ground.

Such a hemispherical-head installing step S150 is performed at both ends of the single pipe 30, whereby both ends of the single pipe 30 may be closed by the hemispherical heads 40, and an outer circumferential surface of the circumferential welding portion 32 may be automatically welded by a welding gantry 100.

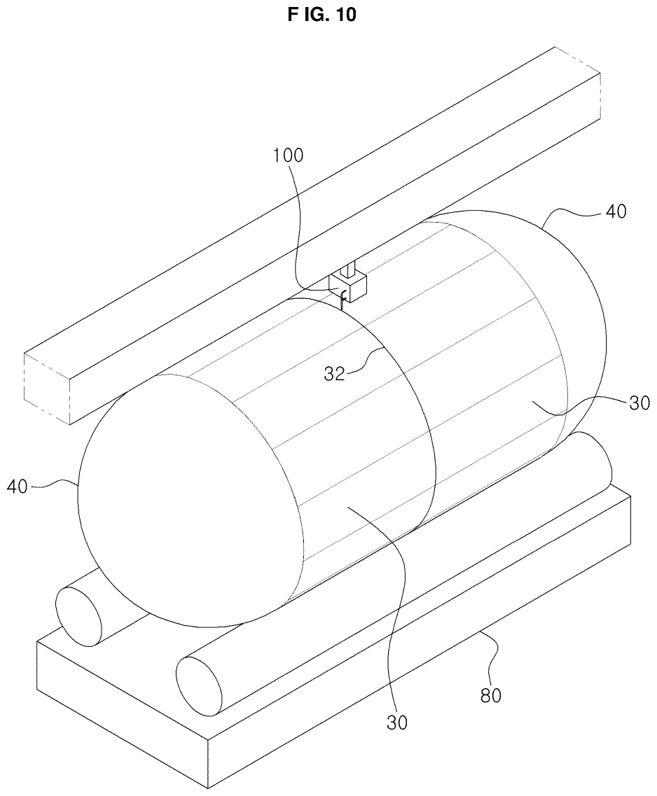

Meanwhile, as shown in FIG. 10, depending on an embodiment, the hemispherical head 40 may be installed to close only one end of the single pipe 30, and in this case, a double-pipe manufacturing step S160 of completing a storage tank formed of a double pipe by coupling a pair of single pipes 30 each having the hemispherical head 40 at one end may be further included.

That is, the pair of single pipes 30 each having the hemispherical head 40 at one end are arranged on the rolling device 80 in a horizontal posture such that open ends thereof face each other symmetrically, and after tack-welding the circumferential welding portion 32 formed between the pair of single pipes 30, the pair of single pipes 30 are rotated by the rolling device 80 and an outer circumferential surface of the circumferential welding portion 32 may be welded by the welding gantry 100.

Meanwhile, the single pipe 30 completed by coupling a plurality of steel plates and the hemispherical head 40 may be heat-treated before being coupled to each other or after being coupled to each other, and after one or more holes are drilled in the single pipe 30 to extend piping of a pump tower installed inside the single pipe 30 to an outside of the single pipe 30 and the pump tower is installed inside the single pipe 30, the hemispherical heads 40 may be installed at both ends of the single pipe 30, or a pair of single pipes 30 each having the hemispherical head 40 at one end may be coupled to each other.

As described above, the method for manufacturing a large-diameter cylindrical storage tank of the present disclosure enables all of a process of manufacturing a single-pipe plate 20 by welding and coupling a plurality of unit steel plates 11, a welding process for a longitudinal welding portion 31 of a single pipe 30 formed by bending the single-pipe plate 20 into a cylindrical shape, a welding process of fixing the ring frames 70 inside the completed single pipe 30, and a welding process of fixing the hemispherical heads 40 to ends of the single pipe 30 to be performed on the ground without installing scaffolding, and since application of automated welding equipment is facilitated, high-quality welding portions may be stably implemented. In addition, when manufacturing a large-area single-pipe plate, a flat single-pipe plate may be manufactured without local twisting or deformation.

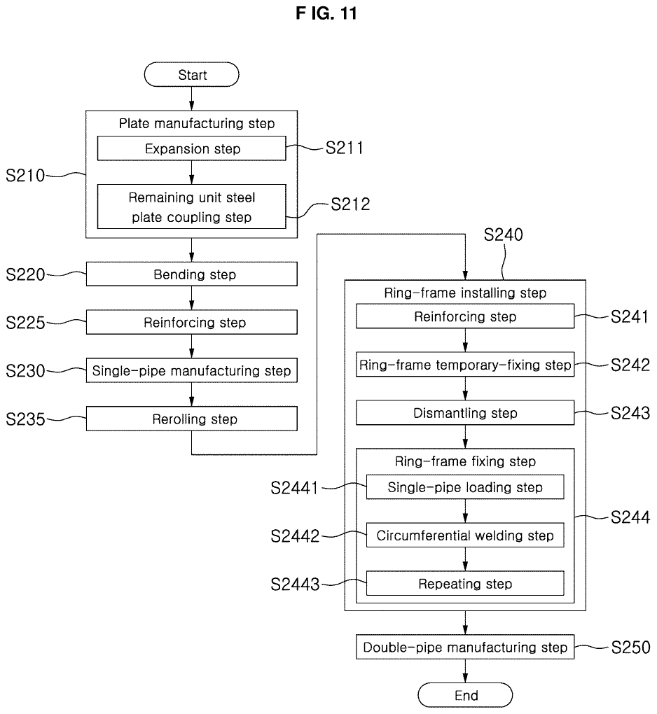

A method for manufacturing a large-diameter cylinder for marine structures according to an embodiment of the present disclosure manufactures a large-diameter cylinder having an inner diameter of several meters or more by coupling a plurality of unit steel plates 11 so that the large-diameter cylinder can be used as a steel pipe for configuring a lower support configured to firmly fix a marine platform for oil or gas extraction or an offshore wind power generator to a seabed, and, as shown in FIG. 11, is sequentially performed through a plate manufacturing step S210, a bending step S220, a single-pipe manufacturing step S230, and a ring-frame installing step S240.

Meanwhile, since the unit steel plates 11 used in the method for manufacturing a large-diameter cylinder for marine structures according to the present embodiment may be the same steel plates as the unit steel plates 11 used in manufacturing the large-diameter storage tank, the same names and reference numerals are used, and the same names and reference numerals are also used for the single-pipe plate 20, the single pipe 30, the welding device 50, the reinforcements 60, the ring frame 70, the rolling device 80, and the manipulator 90.

The plate manufacturing step S210 is a process of manufacturing a single-pipe plate 20 having a length corresponding to a circumferential perimeter of the large-diameter cylinder to be manufactured, and, as shown in FIG. 3, the single-pipe plate 20 is formed by coupling a plurality of unit steel plates 11.

Each of the unit steel plates 11 has a rectangular shape so as to include a long side 11a having a relatively long length and a short side 11b having a relatively short length, and the plurality of unit steel plates 11 are coupled by welding such that the long sides 11a are abutted against each other.

As described above, the plate manufacturing step S210 also manufactures the single-pipe plate 20 having a length corresponding to a circumferential perimeter of the large-diameter cylinder by welding and coupling a plurality of unit steel plates 11 before bending the unit steel plates 11, so that welding between the unit steel plates 11 may be performed through downward-looking welding on the ground, whereby installation of scaffolding for high-altitude work is not required, quality of welding portions may be improved through the downward-looking welding, and welding work may be easily automated.

That is, as shown in FIG. 4A, the unit steel plates 11 are arranged side by side on a surface plate, not shown, and a welding device 50 may perform automatic welding while moving in a horizontal direction along a rail 51 at joints between the unit steel plates 11, or a welding torch 91 installed on a manipulator 90, which will be described later, may perform automatic welding while being moved along the joints between the unit steel plates 11 by the manipulator 90.

The plate manufacturing step S210 includes an expansion step S211 of increasing a length of an assembly 10, formed by coupling two or more unit steel plates 11, twofold, in order to enable efficient operation of the surface plate on which welding work for coupling the unit steel plates 11 is performed and to smoothly perform a series of correction operations for correcting plate deformation of the assembly 10 or the single-pipe plate 20 caused by weld shrinkage deformation.

That is, as shown in FIG. 3, in the expansion step S211, two unit steel plates 11 may be coupled to form a first assembly 10a, the first assembly 10a formed of two unit steel plates 11 may be further coupled to form an expanded second assembly 10b formed of four unit steel plates 11, and the second assembly 10b formed of four unit steel plates 11 may be further coupled to form a more expanded third assembly 10c formed of eight unit steel plates 11, and by repeating such a process, a length of an assembly 10 in which 2ⁿ (n being a natural number) unit steel plates 11 are coupled may be increased twofold.

As described above, since a first assembly 10a formed by coupling a pair of unit steel plates 11, and expanded second and third assemblies 10b and 10c formed by further coupling the first assembly 10a, always have a single new welding portion formed therein, when performing a series of correction operations on the newly formed welding portion of each assembly 10, the correction operations may be effectively performed through localized management at a single point.

In addition, as shown in FIG. 4B, during heat treatment of a straightening process performed after back-side welding for correcting plate deformation caused by welding shrinkage on one side, a plurality of assemblies 10 may be heat-treated at one time, thereby significantly reducing time required for the straightening process, and since the plurality of assemblies 10 formed by coupling the unit steel plates 11 all have the same size, repetitive correction operations may be easily performed, thereby improving work efficiency.

In particular, by welding such that a length of each assembly 10 increases twofold, efficiency of correction processes and straightening processes may be improved, and a flat single-pipe plate 20 may be manufactured without local twisting or deformation resulting from formation of a large-area single-pipe plate 20.

In addition, the plate manufacturing step S210 includes a remaining unit steel plate coupling step S212 of additionally coupling a remaining unit steel plate 11′, which fails to be paired during performance of the expansion step S211, to an assembly 10.

That is, as shown in FIG. 3, when coupling a plurality of unit steel plates 11 in pairs corresponding to a circumferential perimeter of a large-diameter cylinder to be manufactured, if a remaining unit steel plate 11′ that fails to be paired exists, the remaining unit steel plate 11′ may be additionally coupled to an assembly 10 composed of two or more unit steel plates 11.

The bending step S220 is a process of forming a single pipe 30 having a cylindrical shape by bending a flat single-pipe plate 20, and, as shown in FIG. 5, the single-pipe plate 20 may be bent by bending rollers BR to be processed into the single pipe 30 having the cylindrical shape.

Meanwhile, after the bending step S220, a reinforcing step S225 of installing reinforcements 60 on the single pipe 30 may be performed to support the single pipe 30, which is formed by bending the single-pipe plate 20 into a cylindrical shape, so that the single pipe 30 is maintained in a perfect cylindrical shape.

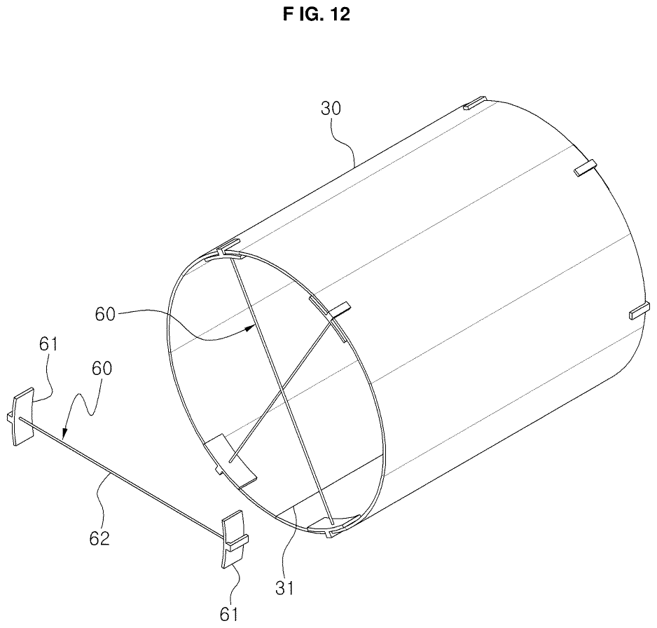

As shown in FIG. 12, each of the reinforcements 60 includes a pair of clamps 61 coupled to an end of the single pipe 30 so as to be symmetric with each other in a radial direction of the single pipe 30, and a rod 62 connecting the pair of clamps 61 to each other, wherein the clamps 61 are fitted to the end of the single pipe 30, and the rod 62 may include a turnbuckle so as to be adjustable in length.

Meanwhile, the reinforcements 60 are respectively installed at both ends of the single pipe 30, and a plurality of the reinforcements 60 are installed at both ends of the single pipe 30 in a crossed manner such that a plurality of the clamps 61 are radially coupled to both ends of the single pipe 30.

As described above, it is preferable that the reinforcements 60 installed on the single pipe 30 remain installed at both ends of the single pipe 30 until the single pipe 30 is completed by welding the longitudinal welding portion 31 of the single pipe 30.

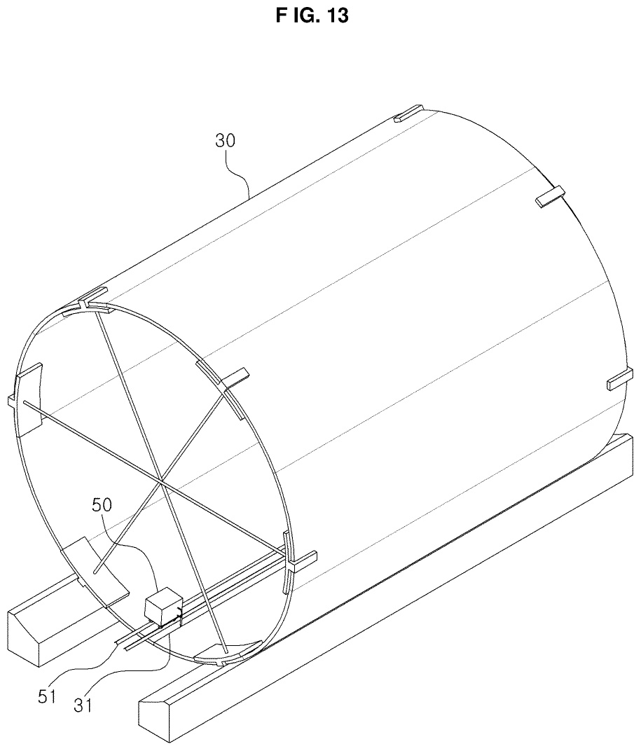

The single-pipe manufacturing step S230 is a process of welding a longitudinal welding portion 31 formed in a single pipe 30 bent into a cylindrical shape, and, as shown in FIG. 13, it is preferable that the single pipe 30 be arranged on a welding bed in a horizontal posture such that the longitudinal welding portion 31 extends in a horizontal posture on a lower side.

When the single pipe 30 is arranged on the welding bed in the horizontal posture as described above, the longitudinal welding portion 31 is positioned at a relatively low location, and thus the longitudinal welding portion 31 may be welded through welding work performed on the ground without installing scaffolding, thereby completing the single pipe 30.

In addition, by temporarily installing a rail 51 for traveling of an automatic welding device 50 inside the single pipe 30 so as to be parallel to the longitudinal welding portion 31, welding of the longitudinal welding portion 31 by using the automatic welding device 50 is possible, and automatic welding by a welding torch 91 installed on and moved by a manipulator 90 is also possible.

In addition, an inner circumferential surface of the longitudinal welding portion 31 may be automatically welded by the automatic welding device 50 or the welding torch 91 of the manipulator 90, and an outer circumferential surface of the longitudinal welding portion 31 may be automatically welded by a welding gantry 100.

After the single-pipe manufacturing step S230 as described above, a rerolling step S235 may be performed by separating and dismantling the reinforcements 60 installed at both ends of the single pipe 30 from the single pipe 30, and bending the completed single pipe 30 again by using the bending rollers BR so as to correct the single pipe 30 to be close to a perfect circle.

The ring-frame installing step S240 is a process of installing a ring frame 70 inside a completed single pipe 30 to support the single pipe 30 so that additional deformation of the single pipe 30 is suppressed, and, as shown in FIG. 11, is sequentially performed by including a reinforcing step S241, a ring-frame temporary-fixing step S242, a dismantling step S243, and a ring-frame fixing step S244.

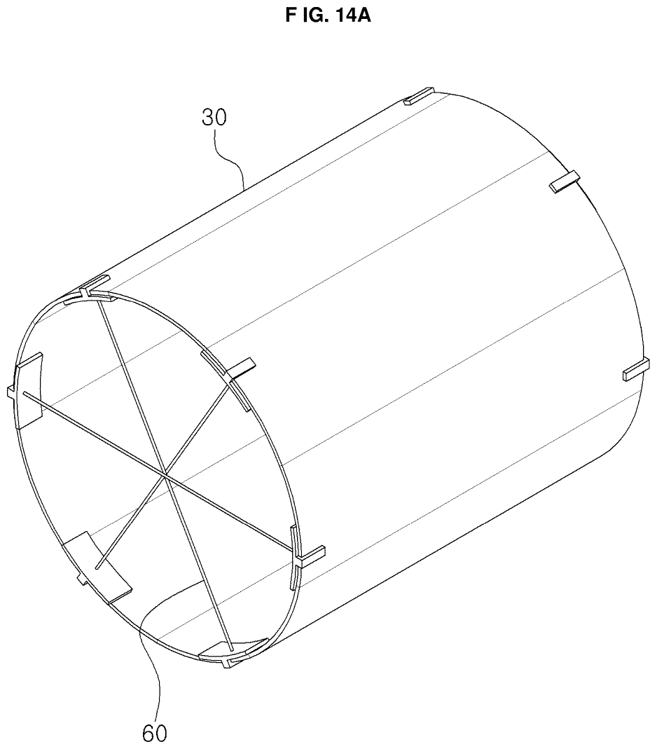

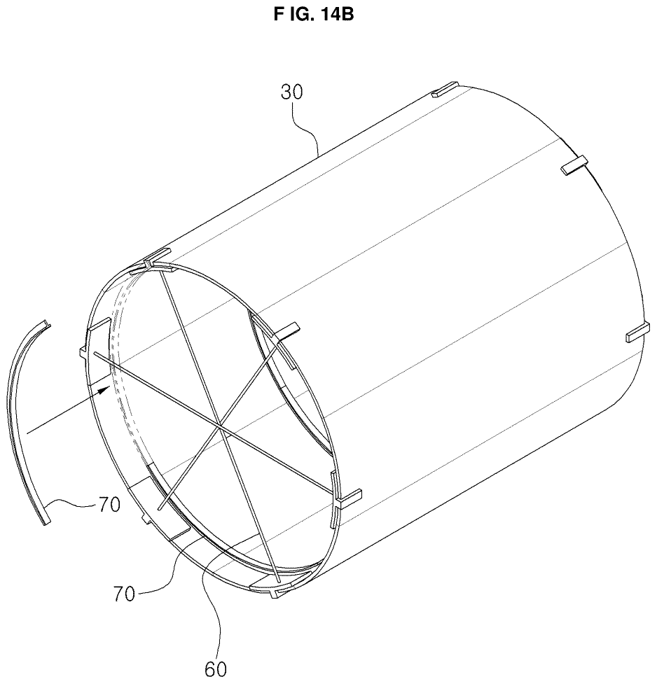

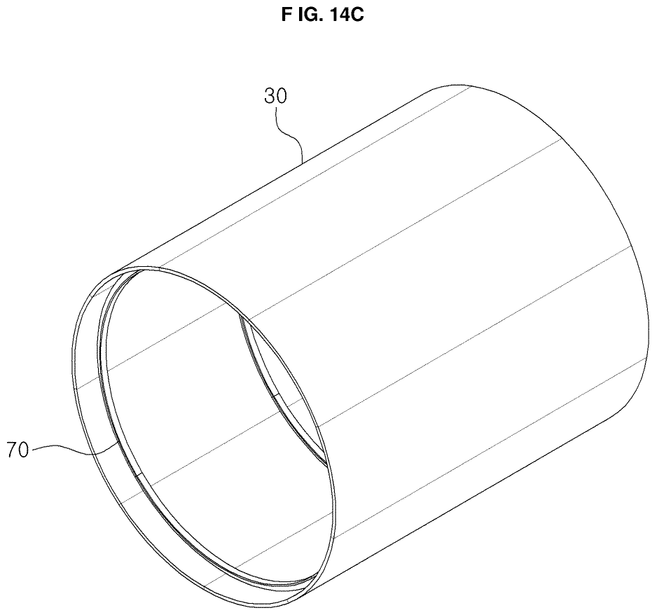

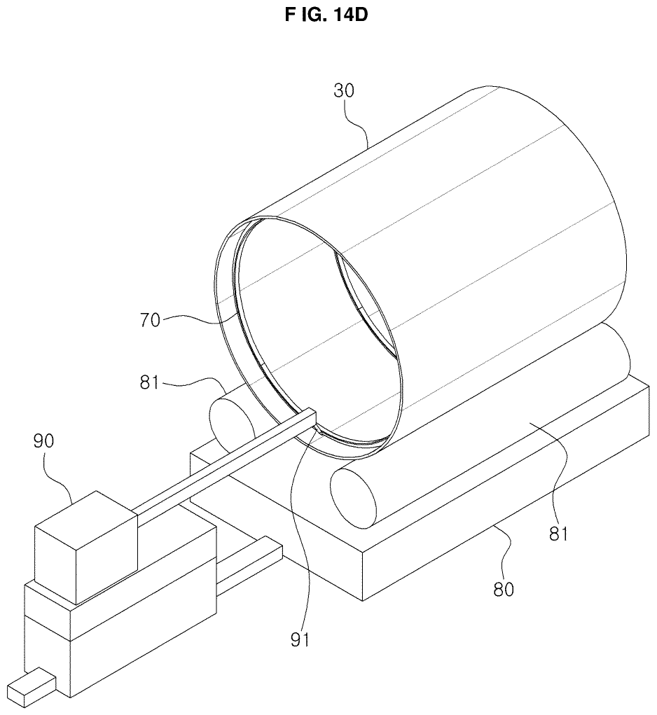

The reinforcing step S241 is a process of installing reinforcements 60 at both ends of the single pipe 30, and, as shown in FIG. 14A, a plurality of the reinforcements 60 are installed at both ends of the single pipe 30 in a manner crossing each other so as to support ends of the single pipe 30 in a perfect circular shape. As described above, since the ring frame 70 is welded and fixed inside the single pipe 30 in a state in which the plurality of reinforcements 60 are installed at both ends of the single pipe 30, deformation of the single pipe 30 caused by welding heat may be suppressed.

Such a reinforcing step S241 is performed immediately after a rerolling step S235 of rerolling the completed single pipe 30 so as to correct the single pipe 30 to be close to a perfect circle, thereby preventing deformation of the single pipe 30 even during transportation of the single pipe 30.

The ring-frame temporary-fixing step S242 is a process of temporarily installing the ring frame 70 inside the single pipe 30, and, as shown in FIG. 14B, the ring frame 70 has an overall circular ring structure, but is divided into a plurality of unit segments so as to be easily inserted into the single pipe 30 through spaces between the reinforcements 60 installed at an end of the single pipe 30, and the unit segments are tack-welded so as to closely contact an inner circumferential surface of the single pipe 30 and thereby fixed inside the single pipe 30, such that the plurality of unit segments form the circular ring structure and are installed to entirely closely contact the inner circumferential surface of the single pipe 30.

As described above, by repeating, along a longitudinal direction of the single pipe 30, a process of temporarily fixing the ring frame 70 inside the single pipe 30 by tack-welding a plurality of unit segments to an inner circumferential surface of the single pipe 30, a plurality of ring frames 70 may be installed in a distributed manner inside the single pipe 30.

The dismantling step S243 is a process of removing the reinforcements 60 installed on the single pipe 30, and, as shown in FIG. 14C, after the ring frame 70 is temporarily fixed inside the single pipe 30, the plurality of reinforcements 60 installed at both ends of the single pipe 30 are separated from the single pipe 30 and dismantled.

The ring-frame fixing step S244 is a process of completely fixing the temporarily fixed ring frame 70 to the single pipe 30, wherein the ring frame 70 is completely fixed by welding along a circumference of the ring frame 70 to the single pipe 30.

Such a ring-frame fixing step S244 includes, as shown in FIG. 11, a single-pipe loading step S2441, a circumferential welding step S2442, and a repeating step S2443 so as to be performed through automatic welding without installing scaffolding or work platforms.

As shown in FIG. 14D, the single-pipe loading step S2441 is a process of loading the single pipe 30, in which the ring frame 70 is temporarily fixed, on a rolling device 80, wherein the single pipe 30 is mounted on the rolling device 80 in a horizontal posture.

The rolling device 80 includes a pair of rotating rollers 81 supporting a single pipe 30 from below, and at least one of the pair of rotating rollers 81 may be rotated by a motor to rotate the single pipe 30.

The circumferential welding step S2442 is a process of welding and fixing a circumference of the ring frame 70 to the single pipe 30, wherein a welding torch 91 whose position is adjusted by a manipulator 90 is positioned to fix the ring frame 70 to the single pipe 30 by downward-looking welding, and the single pipe 30 is rotated at a constant speed by the rolling device 80, whereby the circumference of the ring frame 70 may be welded and fixed to the single pipe 30 without performing high-altitude work.

The repeating step S2443 is a process of completely fixing a plurality of ring frames 70 to the single pipe 30 by repeatedly performing the circumferential welding step S2442 while moving the welding torch in a longitudinal direction of the single pipe 30, wherein the welding torch 91 is moved by the manipulator 90 to a next welding position located along the longitudinal direction of the single pipe 30 and performs welding along the circumference of the ring frame 70 from an inside of the rotating single pipe 30, and by repeating such a process, the plurality of ring frames 70 may be sequentially and completely fixed to the single pipe 30.

Meanwhile, according to an embodiment, a double-pipe manufacturing step S250 of manufacturing a double pipe having an extended length by coupling a pair of single pipes 30 completed by coupling a plurality of unit steel plates 11 may be additionally performed after the ring-frame installing step S240.

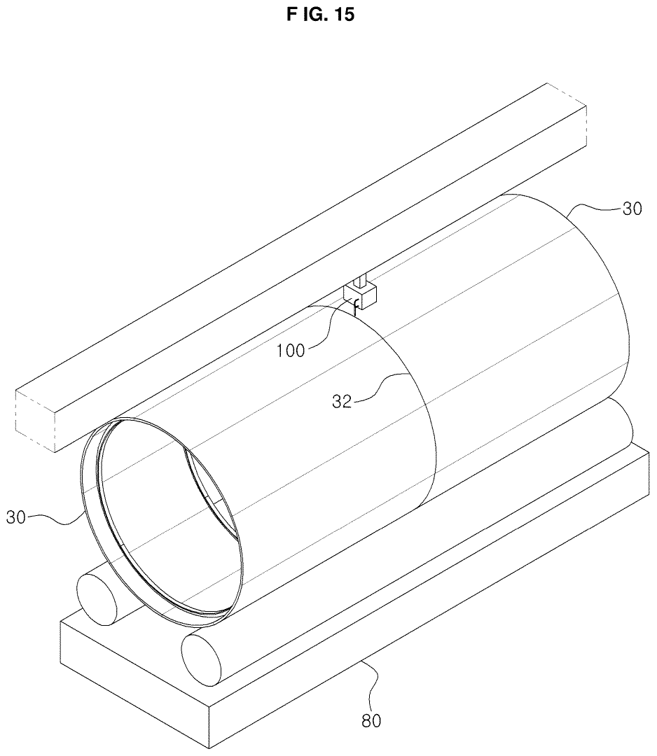

As shown in FIG. 15, the double-pipe manufacturing step S250 is a process of arranging a completed pair of single pipes 30 in a horizontal posture on the rolling device 80 and welding the pair of single pipes 30 to be coupled, wherein the pair of single pipes 30 is arranged on the rolling device 80 such that ends thereof face each other and are in close contact with each other, whereby a circumferential welding portion 32 is formed between the pair of single pipes 30, and the pair of single pipes 30 is temporarily fixed by tack-welding of the circumferential welding portion 32.

As such, the temporarily fixed pair of single pipes 30 is rotated by the rolling device 80, an inner circumferential surface of the circumferential welding portion 32 formed between the pair of single pipes 30 is welded by a welding torch 91 of the manipulator 90, and an outer circumferential surface of the circumferential welding portion 32 is welded by a welding gantry 100, wherein welding by the welding torch 91 and the welding gantry 100 may be performed simultaneously or sequentially.

As configured above, the method for manufacturing a large-diameter cylinder for marine structures of the present disclosure enables all of a process of manufacturing the single-pipe plate 20 by welding and coupling a plurality of unit steel plates 11, a process of welding the longitudinal welding portion 31 of the single pipe 30 formed by bending the single-pipe plate 20 into a cylindrical shape, a process of welding and fixing the ring frame 70 inside the completed single pipe 30, and a process of welding the circumferential welding portion 32 for forming a double pipe by coupling a completed pair of single pipes 30 to be performed on the ground without installation of scaffolding, and allows use of automated welding equipment, thereby stably forming high-quality welding portions. In addition, when manufacturing a large-area single-pipe plate, a flat single-pipe plate may be manufactured without local twisting or deformation.

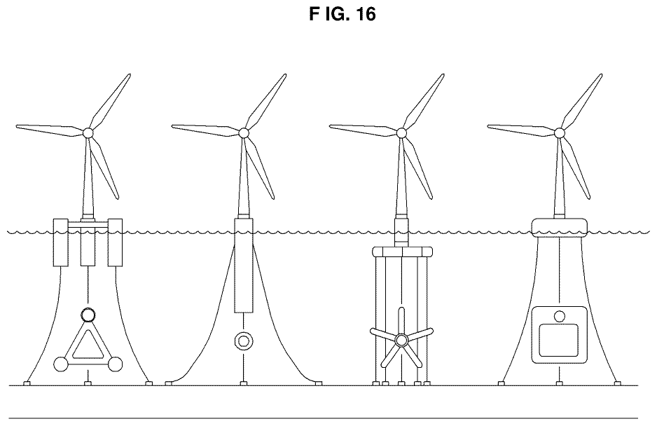

Meanwhile, a cylinder for marine structures manufactured by the method for manufacturing a large-diameter cylinder for marine structures of the present disclosure may be used not only to constitute fixed marine structures but also to constitute marine structures such as a floating offshore wind power tower and a floater, as shown in FIG. 16.

The method for manufacturing a large-diameter cylindrical storage tank, the method for manufacturing a large-diameter cylinder for marine structures, and the storage tank and the cylinder manufactured thereby according to the present disclosure described above may be implemented in other specific forms without departing from the technical spirit or essential characteristics of the present disclosure, as would be understood by a person having ordinary skill in the art to which the present disclosure pertains.

Therefore, the embodiments described above are illustrative in all aspects and should not be construed as limiting, and the scope of the present invention is indicated by the claims described below rather than the foregoing detailed description. All modifications or variations derived from the meaning, scope, and equivalent concepts of the claims should be interpreted as being included within the scope of the present invention.

### DESCRIPTION OF REFERENCE NUMERALS

10: assembly
11: unit steel plate
11a: long side
11b: short side
20: single-pipe plate
30: single pipe
40: hemispherical head
50: welding device
51: rail
60: reinforcement
61: clamp
62: rod
70: ring frame
80: rolling device
81: rotating roller
90: manipulator
91: welding torch
100: welding gantry

1. A method for manufacturing a large-diameter cylindrical storage tank by coupling a plurality of unit steel plates 11, comprising:
a plate manufacturing step S110 of manufacturing a single-pipe plate 20 by welding a plurality of unit steel plates 11 such that long sides 11a of the unit steel plates 11 having a rectangular shape are abutted and coupled to each other;
a bending step S120 of forming a single pipe 30 by bending the single-pipe plate 20 into a cylindrical shape;
a single-pipe manufacturing step S130 of completing the single pipe 30 by arranging the single pipe 30 in a horizontal posture so that a longitudinal welding portion 31 formed in the single pipe 30 bent into the cylindrical shape extends in a horizontal posture, and welding the longitudinal welding portion 31;
a ring-frame installing step S140 of installing one or more ring frames 70 inside the single pipe 30 so as to closely contact an inner circumferential surface of the single pipe 30 to support the single pipe 30; and
a hemispherical-head installing step S150 of installing a hemispherical head 40 at an end of the single pipe 30 to close the end.

2. The method for manufacturing a large-diameter cylindrical storage tank according to claim 1,
wherein the plate manufacturing step S110 includes an expansion step S111 of repeatedly coupling, in pairs, assemblies formed by pairing and coupling the unit steel plates 11 or 2ⁿ unit steel plates 11, where n is a natural number, such that a length of each assembly increases twofold.

3. The method for manufacturing a large-diameter cylindrical storage tank according to claim 2,
wherein the plate manufacturing step S110 includes a remaining unit steel plate coupling step S112 of additionally coupling a remaining unit steel plate 11′ that is not paired during performance of the expansion step S111 to an assembly 10.

4. The method for manufacturing a large-diameter cylindrical storage tank according to claim 1,
wherein the method further includes a double-pipe manufacturing step S160 of arranging, on a rolling device 80 in a horizontal posture so as to be symmetric to each other, a pair of single pipes 30 each provided with the hemispherical head 40 at one end thereof, tack-welding the pair of single pipes 30, and welding a circumferential welding portion 32 while rotating the pair of single pipes 30 by the rolling device 80.

5. The method for manufacturing a large-diameter cylindrical storage tank according to claim 1, further comprising:
after the bending step S120, a reinforcing step S125 of installing reinforcements 60 at both ends of the single pipe 30 so that a shape of the single pipe 30 is maintained as a perfect circle; and
after the single-pipe manufacturing step S130, a rerolling step S135 of separating the reinforcements 60 from the single pipe 30 and correcting the completed single pipe 30 to be close to a perfect circle.

6. The method for manufacturing a large-diameter cylindrical storage tank according to claim 1,
wherein the ring-frame installing step S140 includes:
a reinforcing step S141 of installing reinforcements 60 at both ends of the single pipe 30 so that a shape of the single pipe 30 is maintained as a perfect circle;
a ring-frame temporary-fixing step S142 of temporarily fixing the ring frame 70 to an inner circumferential surface of the single pipe 30;
a dismantling step S143 of separating the reinforcements 60 from the single pipe 30; and
a ring-frame fixing step S144 of welding a circumference of the ring frame 70 to the single pipe 30 so that the ring frame 70 is completely fixed to an inner circumferential surface of the single pipe 30.

7. The method for manufacturing a large-diameter cylindrical storage tank according to claim 6,
wherein the ring-frame fixing step S144 includes:
a single-pipe loading step S1441 of loading the single pipe 30 onto the rolling device 80;
a circumferential welding step S1442 of fixing the ring frame 70 by welding a circumference of the ring frame 70 to the single pipe 30 while rotating the single pipe 30 by the rolling device 80 in a state in which a welding torch whose position is adjusted by a manipulator 90 is positioned at a welding position of the ring frame 70 inside the single pipe 30; and
a repeating step S1443 of sequentially fixing a plurality of ring frames 70 to the single pipe 30 by moving the welding torch in a longitudinal direction of the single pipe 30 by the manipulator 90 and repeating the circumferential welding step S1442.

8. The method for manufacturing a large-diameter cylindrical storage tank according to claim 5,
wherein the reinforcements 60 include a pair of clamps 61 coupled to an end of the single pipe 30 so as to be symmetric with respect to a radial direction of the single pipe 30; and a rod 62 connecting the pair of clamps 61, and
wherein a plurality of the reinforcements 60 are installed at both ends of the single pipe 30 such that a plurality of the clamps 61 are radially coupled to both ends of the single pipe 30.

9. A large-diameter cylindrical storage tank manufactured by the method for manufacturing a large-diameter cylindrical storage tank according to claim 1.

10. A method for manufacturing a large-diameter cylindrical storage tank by coupling a plurality of unit steel plates 11, comprising:
a plate manufacturing step S110 of manufacturing a single-pipe plate 20 by welding a plurality of unit steel plates 11 such that long sides 11a of rectangular unit steel plates 11 are abutted and coupled to each other, wherein an assembly formed by pairing and coupling the unit steel plates 11 or 2ⁿ unit steel plates 11, where n is a natural number, forms an expanded assembly by forming welding portions so that a length of each newly expanded assembly increases twofold for heat treatment for a straightening process;
a bending step S120 of forming a single pipe 30 by bending the single-pipe plate 20 into a cylindrical shape;
a reinforcing step S125 of installing reinforcements 60 at both ends of the single pipe 30 arranged in a horizontal posture so that a shape of the single pipe 30 bent into the cylindrical shape is maintained as a perfect circle;
a single-pipe manufacturing step S130 of arranging the single pipe 30 in a horizontal posture so that a single longitudinal welding portion 31 formed in the single pipe 30 bent into the cylindrical shape extends in a horizontal posture, and completing the single pipe 30 by welding the longitudinal welding portion 31;
a ring-frame installing step S140 of installing one or more ring frames 70 inside the single pipe 30 so as to closely contact an inner circumferential surface of the single pipe 30 to support the single pipe 30, including a reinforcing step S141 of installing a plurality of reinforcements 60 at both ends of the single pipe 30 arranged in a horizontal posture so that the shape of the single pipe 30 is maintained as a perfect circle, a ring-frame temporary-fixing step S142 of temporarily fixing a ring frame 70 divided into a plurality of unit segments to the inner circumferential surface of the single pipe 30, a dismantling step S143 of separating the reinforcements 60 from the single pipe 30, and a ring-frame fixing step S144 of welding a circumference of the ring frame 70 to the single pipe 30 so that the ring frame 70 is completely fixed to the inner circumferential surface of the single pipe 30; and
a hemispherical-head installing step S150 of installing a hemispherical head 40 at an end of the single pipe 30 to close the end,
wherein each reinforcement 60 includes a pair of clamps 61 fitted to an end of the single pipe 30 so as to be symmetric with respect to a radial direction of the single pipe 30, and a rod 62 connecting the pair of clamps 61, and a plurality of the reinforcements 60 are installed at both ends of the single pipe 30 such that a plurality of the clamps 61 are radially coupled to both ends of the single pipe 30.

11. A method for manufacturing a large-diameter cylinder for marine structures by coupling a plurality of unit steel plates 11 to manufacture a large-diameter cylinder for forming a lower support of a marine structure, comprising:
a plate manufacturing step S210 of manufacturing a single-pipe plate 20 by welding a plurality of unit steel plates 11 such that long sides 11a of the unit steel plates 11 having a rectangular shape are abutted and coupled to each other;
a bending step S220 of forming a single pipe 30 by bending the single-pipe plate 20 into a cylindrical shape;
a single-pipe manufacturing step S230 of arranging the single pipe 30 in a horizontal posture so that a longitudinal welding portion 31 formed in the single pipe 30 bent into the cylindrical shape extends in a horizontal posture, and completing the single pipe 30 by welding the longitudinal welding portion 31; and
a ring-frame installing step S240 of installing one or more ring frames 70 inside the single pipe 30 so as to closely contact an inner circumferential surface of the single pipe 30 to support the single pipe 30.

12. The method for manufacturing a large-diameter cylinder for marine structures according to claim 11, further comprising:
after the ring-frame installing step S240, a double-pipe manufacturing step S250 of arranging a pair of single pipes 30 on a rolling device 80 in a horizontal posture, tack-welding a circumferential welding portion 32 formed between the pair of single pipes 30, and then welding the circumferential welding portion 32 while rotating the pair of single pipes 30 by the rolling device 80.

13. The method for manufacturing a large-diameter cylinder for marine structures according to claim 11,
wherein the plate manufacturing step S210 includes an expansion step S211 of repeatedly coupling, in pairs, assemblies formed by pairing and coupling the unit steel plates 11 or 2ⁿ unit steel plates 11, where n is a natural number, such that a length of each assembly increases twofold.

14. A large-diameter cylinder for marine structures manufactured by the method for manufacturing a large-diameter cylinder for marine structures according to claim 11.

15. A method for manufacturing a large-diameter cylinder for marine structures by coupling a plurality of unit steel plates 11 to manufacture a large-diameter cylinder for forming a lower support of a marine structure, comprising:
a plate manufacturing step S210 of manufacturing a single-pipe plate 20 by welding a plurality of unit steel plates 11 such that long sides 11a of the unit steel plates 11 having a rectangular shape are abutted and coupled to each other, wherein an assembly formed by pairing and coupling the unit steel plates 11 or 2ⁿ unit steel plates 11, where n is a natural number, forms an expanded assembly such that a length of the assembly is increased twofold, and wherein only one new welding portion is formed in each newly expanded assembly for heat treatment for a straightening process;
a bending step S220 of forming a single pipe 30 by bending the single-pipe plate 20 into a cylindrical shape;
a reinforcing step S225 of installing reinforcements 60 at both ends of the single pipe 30 arranged in a horizontal posture so that a shape of the single pipe 30 bent into the cylindrical shape is maintained as a perfect circle;
a single-pipe manufacturing step S230 of arranging the single pipe 30 in a horizontal posture so that a longitudinal welding portion 31 formed in the single pipe 30 bent into the cylindrical shape extends in a horizontal posture, and completing the single pipe 30 by welding the longitudinal welding portion 31; and
a ring-frame installing step S240 including: a reinforcing step S241 of installing a plurality of reinforcements 60 at both ends of the single pipe 30 arranged in a horizontal posture so that a shape of the single pipe 30 is maintained as a perfect circle, a ring-frame temporary-fixing step S242 of temporarily fixing a ring frame 70 divided into a plurality of unit segments to an inner circumferential surface of the single pipe 30, a dismantling step S243 of separating the reinforcements 60 from the single pipe 30, and a ring-frame fixing step S244 of welding a circumference of the ring frame 70 to the single pipe 30 so that the ring frame 70 is completely fixed to the inner circumferential surface of the single pipe 30, thereby installing one or more ring frames 70 inside the single pipe 30 to closely contact the inner circumferential surface of the single pipe 30 so as to support the single pipe 30,
wherein each of the reinforcements 60 includes a pair of clamps 61 fitted to an end of the single pipe 30 so as to be symmetric with each other in a radial direction of the single pipe 30, and a rod 62 connecting the pair of clamps 61, and a plurality of the reinforcements 60 are installed at both ends of the single pipe 30 such that a plurality of the clamps 61 are radially coupled to both ends of the single pipe 30.
